(19) United States
(12) Patent Application Publication
(10) Pub. No.: US 2006/0253891 A1
(43) Pub. Date: Nov. 9, 2006

(54) Multi-channel wireless digital video monitoring system

(76) Inventor: Ming-Tsen Wu, Quarry Bay (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,513

(22) Filed: Mar. 29, 2005

(51) Int. Cl. H04N 7/16

(52) U.S. Cl. 725/151

(57) ABSTRACT

A multi-channel wireless digital video monitoring system includes a central equipment, several wireless cameras, which can receive signals transmitted from the wireless cameras at the same time; the central equipment has a receiving antenna; each wireless camera has a transmitting antenna; when the cameras capture video images, the receiving antennas will receive signals transmitted from the transmitting antennas, and the signals will be filtered and magnified by a high frequency processing circuit of the signal receiving device, and then a mixer circuit will mix the signals with oscillating signals from a local oscillating circuit, and as many groups of medium frequency signals as the wireless cameras will be produced; then, the medium frequency signals will be demodulated and processed by a video processing circuit, video channel control circuit and digital video processing circuit, and video images will be shown on the monitors if the device is connected to the video input terminal of monitor.

### BACKGROUND OF THE INVENTION

1. Field of the Invention

The present invention relates to a wireless signal receiving device of a digital video monitoring system, more particularly one, which can receive wireless signals transmitted from several wireless video cameras at the same time such that there is single receiving antenna, and the digital video monitoring system has decreased number of parts and less chance of breakdown, and is cheaper to use.

2. Brief Description of the Prior Art

Many kinds of wireless equipments are available, e.g. wireless monitoring systems, wireless earphones, wireless microphones, remote controls, wireless doorbells, and wireless speakers, which are relatively convenient to use, and popular because they have no wires exposed to spoil the look of the environment.

Referring to FIG. 3, a conventional wireless video monitoring system includes a central equipment 72, and several wireless video cameras 71. Each of the wireless video cameras 71 has a transmitting antenna 711, and is located in a respective place. The central equipment 72 has several receiving antennas 73, which are used with respective ones of the transmitting antennas 711 of the wireless video cameras 71. And, monitors 74 are electrically connected to the central equipment 72. Thus, when the video monitoring system is activated, the video cameras 71 will record video images, and the transmitting antennas 711 of the video cameras 71 will transmit signals, and the receiving antennas 73 of the main equipment 72 will receive the signals, and in turn the video images are shown on the screens 74.

However, the conventional wireless video monitoring system has too many parts and high chance of breakdown, and isn't economical to use because it has many receiving antennas for use with respective ones of the video cameras.

### SUMMARY OF THE INVENTION

It is a main object of the invention to provide an improvement on a digital video monitoring system to overcome the above problem.

The digital video monitoring system includes a central equipment, several wireless video cameras, and a wireless signal receiving device, which can receive signals transmitted from the video cameras at the same time. The central equipment has a receiving antenna, and monitors are connected the central equipment. Each video camera has a transmitting antenna. When the cameras records video images, the receiving antennas will receive signals transmitted from the transmitting antennas, and the signals will be filtered and magnified by a high frequency processing circuit of the signal receiving device, and a mixer circuit will mix the signals with oscillating signals from a local oscillating circuit; thus, as many groups of medium frequency signals as the video cameras will be produced. Then, the medium frequency signals will be modulated and processed by a modulated image processing circuit, and in turn video images recorded through the cameras are shown on the monitors.

### BRIEF DESCRIPTION OF THE DRAWINGS

The present invention will be better understood by referring to the accompanying drawings, wherein:

FIG. 1 is a perspective view of the present invention,

FIGS. 2A-2C are circuit-block diagrams of the present invention, and

FIG. 3 is a perspective view of the prior art described in the Background.

### DETAILED DESCRIPTION OF THE PREFERRED EMBODIMENTS

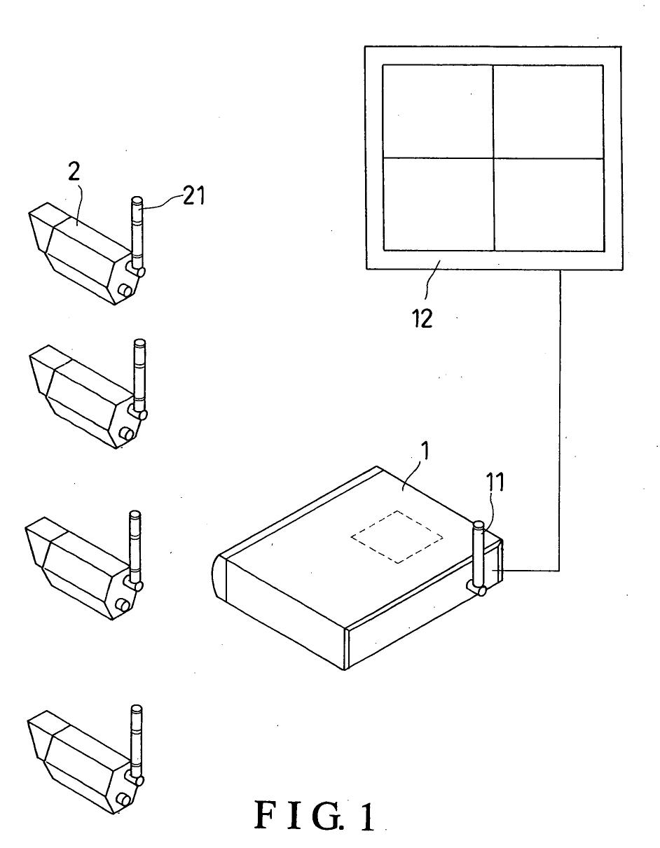

Referring to FIG. 1, a preferred embodiment of a digital video monitoring system includes a central equipment 1, and several wireless video cameras 2. The central equipment 1 has a receiving antenna 11 while monitors 12 are electrically connected the central equipment 1. Each of the video cameras 2 has a transmitting antenna 21.

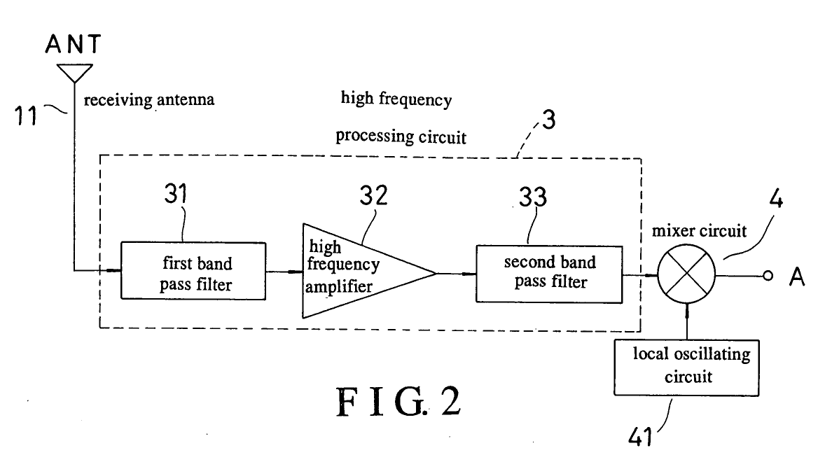

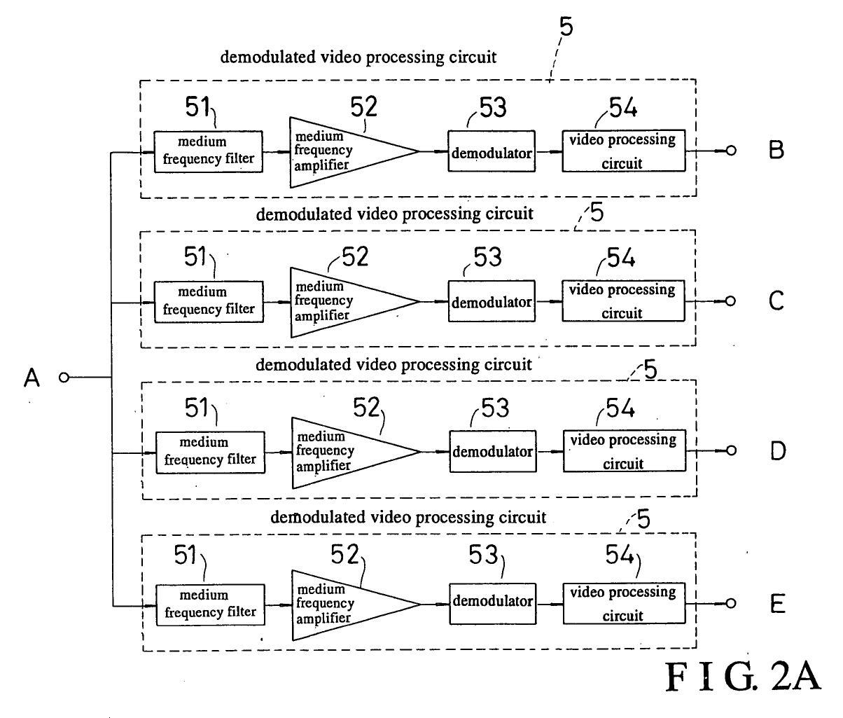

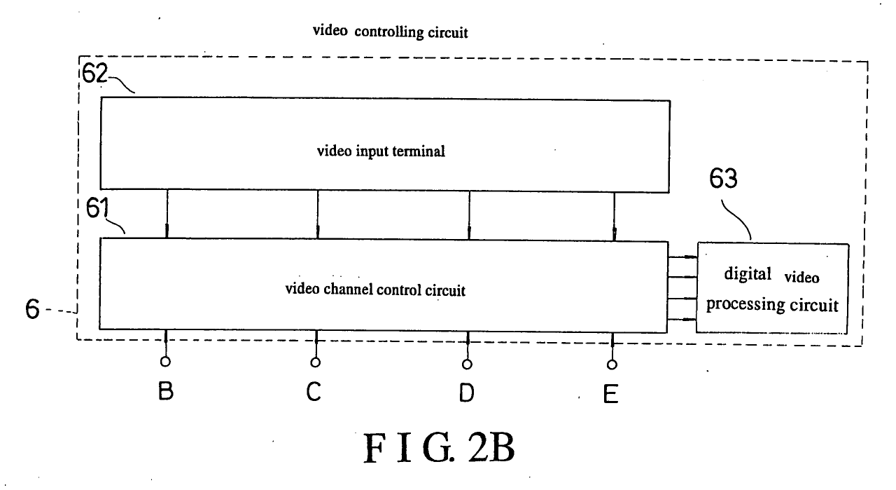

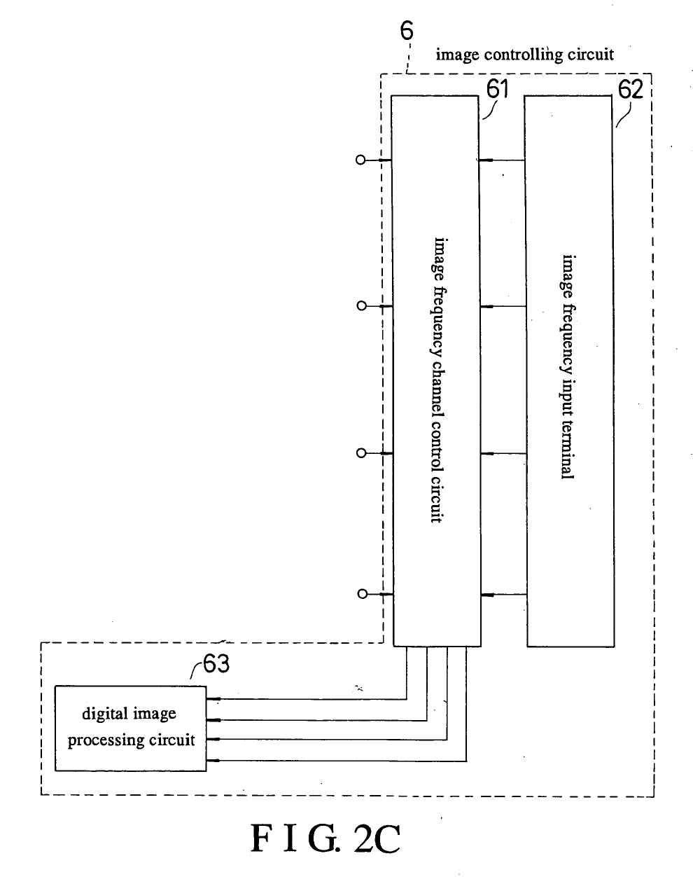

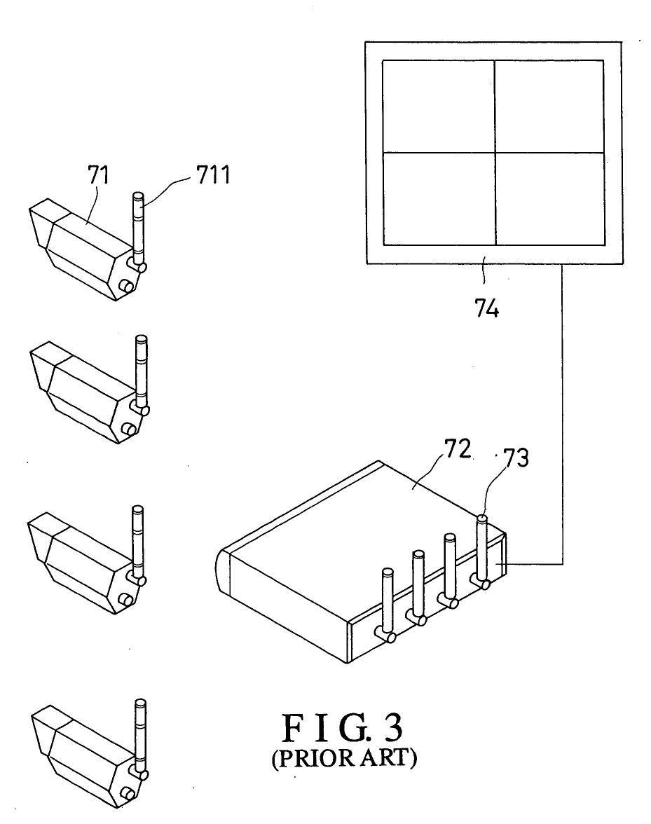

Referring to FIG. 2 as well, the receiving antenna 11 of the central equipment 1 is connected to a high frequency processing circuit 3, and the high frequency processing circuit 3 is connected to a mixer circuit 4. The mixer circuit 4 is connected to several modulated image processing circuits 5, which are used with respective ones of the video cameras 2, and which are connected to an image controlling circuit 6. The high frequency processing circuit 3 includes a first band pass filter 31, a high frequency amplifier 32 connected to the first band pass filter 31, and a second band pass filter 33 connected to the high frequency amplifier 32. The mixer circuit 4 is connected to the high frequency processing circuit 3, and it is connected to a local oscillating circuit 41 at an input terminal thereof.

Each of the modulated image processing circuits 5 includes a medium frequency filter 51, a medium frequency amplifier 52 connected to the medium frequency filter 51, a modulator 53 connected to the medium frequency amplifier 52, and an image processing circuit 54 connected to the modulator 53. The image controlling circuit 6 includes an image frequency channel control circuit 61, which is connected to each and every one of the modulated image processing circuits 5, and which has an image frequency input terminal 62 for connection to external wired image input signals. In addition, the image frequency channel control circuit 61 is connected to input terminals of a digital image processing circuit 63 at output terminals thereof, which digital image processing circuit 63 is connected to the screens 12 connected to the central equipment 1.

Therefore, when the digital video monitoring system is activated, the video cameras 2 will record video images, and the transmitting antennas 21 will transmit signals accordingly, and the receiving antennas 11 of the central equipment 1 will receive the signals transmitted from the transmitting antennas 21. And, the signals will be filtered and magnified by means of the high frequency processing circuit 3, and then the mixer circuit 4 will mix the signals with oscillating signals from the local oscillating circuit 41; thus, as many groups of medium frequency signals as the numbers of the video cameras 2 will be produced. Then, the medium frequency signals will be modulated and imagewise processed by means of the modulated image processing circuit 5, and in turn video images are shown on the monitors 12 through the image controlling circuit 6.

From the above description, it can be easily understood that because the digital video monitoring system of the present invention has single receiving antenna, it has fewer parts and less chance of breakdown, and it is more economical to use when compared with the conventional digital video monitoring system described in Background.

1. A multi-channel wireless digital video monitoring system, comprising:
(a) a central equipment; the main equipment having a receiving antenna;
(b) a plurality of wireless cameras; each of the wireless cameras having a transmitting antenna;
(c) a high frequency processing circuit connected to the receiving antenna of the central equipment; the high frequency processing circuit including a first band pass filter, a high frequency amplifier connected to the first band pass filter, and a second band pass filter connected to the high frequency amplifier;
(d) a mixer connected to the high frequency processing circuit; the mixer circuit being connected to a local oscillating circuit at an input terminal thereof;
(e) a plurality of demodulated video processing circuits connected to the mixer circuit to be used with respective ones of the wireless cameras; each of the demodulated video processing circuits including a medium frequency filter, a medium frequency amplifier connected to the medium frequency filter, a demodulator connected to the medium frequency amplifier, and a video processing circuit connected to the demodulator; and
(f) a video controlling circuit connected to the demodulated video processing circuits; the image controlling circuit having a video channel control circuit, which is connected to each and every one of the demodulated video processing circuits; the video channel control circuit having a video input terminal for connection to external wired video input signals; the video channel control circuit being connected to input terminals of a digital video processing circuit at output terminals thereof; the digital video processing circuit with monitor port which can be connected to the monitors, and video image will be shown on the monitor;
whereby the wireless signal receiving device will receive wireless signals transmitted from plural wireless cameras at a same time.
